(19) United States
(12) Patent Application Publication
(10) Pub. No.: US 2026/0160694 A1
(43) Pub. Date: Jun. 11, 2026

(54) SERS SUBSTRATE STRUCTURE FOR CHEMICAL DETECTION BY USING METAL-LIGAND COORDINATION BOND, MANUFACTURING METHOD THEREOF, AND CHEMICAL DETECTION METHOD USING SERS

(71) Applicant: Seoul National University R&DB foundation, Seoul (KR)

(72) Inventors: Dae Hong Jeong, Seoul (KR); Kyunghun Kim, Seoul (KR)

(21) Appl. No.: 18/718,294

(22) PCT Filed: Dec. 20, 2023
(86) PCT No.: PCT/KR2023/021087

§ 371 Date: Jun. 10, 2024

(30) Foreign Application Priority Data
Feb. 3, 2023 (KR) 10-2023-0014551

(51) Int. Cl. G01N 21/65; B82Y 15/00; B82Y 40/00

(52) U.S. Cl. CPC G01N 21/658; B82Y 15/00; B82Y 40/00

(57) ABSTRACT

Provided is a SERS substrate structure for chemical detection including a plasmonic nanofilm having a first functional group on a surface, a metal ion disposed on the surface of the plasmonic nanofilm, a target molecule disposed on the surface of the plasmonic nanofilm and having a second functional group, and a plasmonic nanostructure which is disposed on the surface of the plasmonic nanofilm with the metal ion and the target molecule interposed therebetween to cause surface-enhanced Raman scattering (SERS), wherein the first functional group and the second functional group may form a coordination compound through the metal ion.

### TECHNICAL FIELD

The present invention relates to a structure for detecting a substance and its manufacturing and application, and more particularly, to a substrate structure for detecting a chemical substance, a manufacturing method thereof, and a method for detecting a chemical substance.

### BACKGROUND ART

Surface-enhanced Raman scattering (hereinafter, SERS) is a phenomenon in which the Raman scattering signal which is a unique spectrum that appears when light passes through a substance is amplified by plasmon on the surface of a metal, etc., and may be applied to detect trace amounts of small molecular substances.

However, the existing SERS application technology has a limitation in that measurement targets are limited to only molecules with affinity to the surface of metals such as silver (Ag) or gold (Au). For example, SERS technology could only be applied to molecular (low molecule) substances which could specifically bind to a metal nanostructure.

There is a demand for detection of very small amounts of low-molecular substances in various fields such as medicine, pharmaceuticals, food, and art, and a universal measurement protocol which may detect low-molecular substances in various fields is required. Therefore, the technologies and the methods which may expand the range of substances (molecules) that may be detected/measured by using the SERS method are required. In addition, in the development of SERS-related technology, it is necessary to develop technology which is easy to mass-produce and may be easily utilized even by personnel with low technological skills.

### DISCLOSURE OF THE INVENTION

### Technical Problem

The technological problem to be achieved by the present invention is to provide a SERS substrate structure for chemical detection which may dramatically expand the range of substances (molecules) that may be detected/measured using the SERS (surface-enhanced Raman scattering) method, and a manufacturing method thereof.

In addition, the technological object to be achieved by the present invention is to provide a SERS substrate structure for chemical detection which may be easily mass-produced and easily utilized by personnel with low technological skills, and a manufacturing method thereof.

In addition, the technological object to be achieved by the present invention is to provide a chemical detection method by applying the SERS substrate structure for chemical detection.

The object to be solved by the present invention is not limited to the objects mentioned above, and other objects not mentioned will be understood by those skilled in the art from the description below.

### Technical Solution

According to one embodiment of the present invention, there is provided a SERS substrate structure for chemical detection comprising: a plasmonic nanofilm having a first functional group on a surface; a metal ion disposed on the surface of the plasmonic nanofilm; a target molecule disposed on the surface of the plasmonic nanofilm and having a second functional group; and a plasmonic nanostructure which is disposed on the surface of the plasmonic nanofilm with the metal ion and the target molecule interposed therebetween to cause surface-enhanced Raman scattering (SERS), wherein the first functional group and the second functional group form a coordination compound through the metal ion.

The plasmonic nanofilm may contain a metal.

The plasmonic nanofilm may include, for example, at least one of Au, Ag, and Pt.

The first functional group may include, for example, at least one of a hydroxyl group, an amino group, and a carboxyl group.

The metal ion may include, for example, at least one of Al ion, Ni ion, Cu ion, and Fe ion.

The second functional group may include at least one of, for example, a phenol group, a ketone group, a hydroxyl group, an amino group, an azo group, and a carboxyl group.

The plasmonic nanostructure may, for example, have the form of nanoparticles.

The plasmonic nanostructure may include a metal.

The plasmonic nanostructure may include, for example, at least one of Au, Ag, and Pt.

According to another embodiment of the present invention, there is provided a chemical detection method using SERS comprising: preparing a plasmonic nanofilm having a first functional group on a surface; introducing a metal ion onto the surface of the plasmonic nanofilm; introducing a target molecule having a second functional group on the surface of the plasmonic nanofilm to induce the first functional group and the second functional group to form a coordination compound through the metal ion; disposing a plasmonic nanostructure which causes surface-enhanced Raman scattering (SERS) on the surface of the plasmonic nanofilm with the metal ion and the target molecule interposed therebetween; and detecting a SERS signal generated between the plasmonic nanofilm and the plasmonic nanostructure.

The preparing the plasmonic nanofilm having the first functional group may include preparing a nanofilm; and introducing the first functional group to a surface of the nanofilm by treating the surface of the nanofilm with a solution containing a surface modification material.

The surface modification material may include, for example, 2-mercaptoethanol.

The plasmonic nanofilm may contain a metal.

The plasmonic nanofilm may include, for example, at least one of Au, Ag, and Pt.

The first functional group may include, for example, at least one of a hydroxyl group, an amino group, and a carboxyl group.

The metal ion may include, for example, at least one of Al ion, Ni ion, Cu ion, and Fe ion.

The second functional group may include at least one of, for example, a phenol group, a ketone group, a hydroxyl group, an amino group, an azo group, and a carboxyl group.

The plasmonic nanostructure may, for example, have a form of a nanoparticle.

The plasmonic nanostructure may include a metal.

The plasmonic nanostructure may include, for example, at least one of Au, Ag, and Pt.

### Advantageous Effects

According to embodiments of the present invention, it is possible to implement a SERS substrate structure for chemical detection which may dramatically expand the range of substances (molecules) that may be detected/measured by the SERS method. In particular, it is possible to implement a SERS substrate structure which may be used universally for molecular substances which do not form specific bonds with metal nanostructures.

In addition, according to embodiments of the present invention, it is possible to implement a SERS substrate structure for chemical detection which may be easily mass-produced and easily utilized even by personnel with low technological skills, and a related method thereof.

The method for detecting chemical substances using the SERS substrate structure for chemical detection according to embodiments of the present invention may be usefully applied across a wide range of fields, such as medicine, pharmaceuticals, food, and art.

However, the effects of the present invention are not limited to the above effects and may be expanded in various ways without departing from the technological spirit and scope of the present invention.

### BRIEF DESCRIPTION OF THE DRAWINGS

FIG. 1 is a cross-sectional diagram showing a surface-enhanced Raman scattering (SERS) substrate structure for chemical detection according to an embodiment of the present invention.

FIG. 2 is a diagram illustrating a manufacturing method of a SERS substrate structure for chemical detection and a chemical detection method by applying the same according to an embodiment of the present invention.

FIG. 3 is a scanning electron microscope (SEM) image showing Au nanoparticles (i.e., AuNPs) which may be applied to a SERS substrate structure for chemical detection according to an embodiment of the present invention.

FIG. 4 is an atomic force microscope (AFM) image of the surface of an Au nanofilm (i.e., AuNF) that may be applied to a SERS substrate structure for chemical detection according to an embodiment of the present invention.

FIG. 5 is a graph showing the SERS spectrum of 4-MBA (4-mercaptobenzoic acid) for each of a substrate structure (i.e., AuNP-on-AuNF substrate structure) into which AuNPs (a plurality of AuNPs) were introduced (attached) on AuNF, and AuNF into which AuNPs were not introduced (attached).

FIG. 6 is a graph showing 4-MBA SERS spectra at different measurement points of a substrate structure in which AuNPs were introduced (attached) on AuNF (i.e., AuNP-on-AuNF substrate structure).

FIG. 7 is a schematic diagram of nanogap setting for calculating a SERS enhancement factor (EF) in the nanogap (or hot-spot) of a substrate structure in which AuNP is introduced (attached) on AuNF (i.e., AuNP-on-AuNF substrate structure).

FIG. 8 is a heatmap graph showing the SERS mapping results for shikonin, which is a target molecule, when no coordination compound was formed on the AuNP-on-AuNF substrate structure.

FIG. 9 is a diagram illustrating a heatmap graph (graph illustrated at the lower portion of the drawing) showing the SERS mapping results for shikonin, which is a target molecule, and a representative SERS spectrum (spectrum observed at the upper portion of the drawing) when a coordination compound was formed on the AuNP-on-AuNF substrate structure.

FIG. 10 is a graph showing the results of SERS analysis of various molecular substances using an AuNP-on-AuNF substrate structure to which a coordination compound prepared according to an embodiment of the present invention is applied.

### BEST MODE FOR CARRYING OUT THE INVENTION

Hereinafter, embodiments of the present invention will be described in detail with reference to the accompanying drawings.

The embodiments of the present invention to be described below are provided to more clearly explain the present invention to those skilled in the art, and the scope of the present invention is not limited by the following embodiments, and the embodiments may be modified in many different forms.

The terms used in this specification are used to describe specific embodiments and are not intended to limit the present invention. The terms indicating a singular form used herein may include plural forms unless the context clearly indicates otherwise. Also, as used herein, the terms, “comprise” and/or “comprising” specify the presence of the stated shape, step, number, operation, member, device, and/or group thereof and does not exclude the presence or addition of one or more other shapes, steps, numbers, operations, devices, devices and/or groups thereof. In addition, the term, “connection” used in this specification means not only a direct connection of certain members, but also a concept including an indirect connection in which other members are interposed between the members.

In addition, in the present specification, when a member is said to be located “on” another member, this arrangement includes not only a case in which a member is in contact with another member, but also a case where another member exists between the two members. As used herein, the term, “and/or” includes any one and all combinations of one or more of the listed items. In addition, the terms of degree such as “about” and “substantially” used in the present specification are used as a range of values or degrees, or as a meaning close thereof, taking into account inherent manufacturing and substance tolerances, and exact or absolute figures provided to aid in the understanding of this application are used to prevent the infringers from unfairly exploiting the stated disclosure.

Hereinafter, embodiments of the present invention will be described in detail with reference to the accompanying drawings. A size or a thickness of areas or parts shown in the accompanying drawings may be slightly exaggerated for clarity of the specification and convenience of description. The same reference numbers indicate the same configuring devices throughout the detailed description.

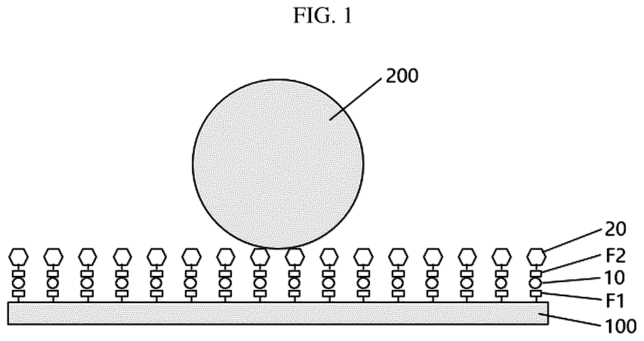

FIG. 1 is a cross-sectional diagram showing a surface-enhanced Raman scattering (SERS) substrate structure for chemical detection according to an embodiment of the present invention.

Referring to FIG. 1, the SERS substrate structure for chemical detection according to an embodiment of the present invention may include a plasmonic nanofilm 100 having a first functional group F1 on a surface, a metal ion 10 disposed on the surface of the plasmonic nanofilm 100, a target molecule 20 disposed on the surface of the plasmonic nanofilm 100 and having a second functional group F2, and a plasmonic nanostructure 200 disposed on the surface of the plasmonic nanofilm 100 with the metal ion 10 and the target molecule 20 therebetween to induce SERS. Here, the first functional group F1 and the second functional group F2 may form a coordination compound through the metal ion 10.

The plasmonic nanofilm 100 may be a film which may induce a surface plasmon effect. The plasmonic nanofilm 100 may have a flat plate-shaped structure or a substantially flat plate-shaped structure. The plasmonic nanofilm 100 may be placed on a predetermined base substrate (not shown). For example, the plasmonic nanofilm 100 may have a thickness of about 1 nm or more and less than about 1 μm. The width and length of the plasmonic nanofilm 100 may be, for example, several mm to hundreds of mm, but are not limited thereof.

The plasmonic nanofilm 100 may contain a metal or be formed of a metal. For example, the plasmonic nanofilm 100 may include at least one of Au, Ag, and Pt. In this case, it may be easy to induce surface plasmon due to the plasmonic nanofilm 100. However, the specific material of the plasmonic nanofilm 100 is not limited to the above substances.

The first functional group F1 may include, for example, at least one of a hydroxyl group, an amino group, and a carboxyl group. The first functional group F1 may be attached (introduced) to the surface of the plasmonic nanofilm 100 through a surface modification process on the surface (e.g., at least the top surface) of the plasmonic nanofilm 100.

The metal ion 10 may include, for example, at least one of Al ion, Ni ion, Cu ion, and Fe ion. The metal ion 10 may be expressed as Mⁿ⁺, where M may be any one of Al, Ni, Cu, and Fe, and n may be 2 to 3. However, the specific type of metal ion 10 is not limited to the above and may vary.

The target molecule 20 is a molecule which is subject to analysis/measurement and may include a single molecule or a low molecule (small molecule). Here, the low molecule may refer to a molecule having a molecular weight of about 1000 daltons or less. The target molecule 20 may have the second functional group F2. The second functional group F2 may include at least one of for example, a phenol group, a ketone group, a hydroxyl group, an amino group, an azo group, and a carboxyl group. The second functional group F2 may be a single functional group or a plurality of functional groups. The single functional group may be bonded to one metal ion 10 or the plurality of functional groups may be bonded to one metal ion 10.

The first functional group F1 and the second functional group F2 may form a coordination compound through the metal ion 10. In other words, the second functional group F2 may be coordinated with the first functional group F1 through the metal ion 10. It may be said that the coordination compound includes the first functional group F1, the second functional group F2, and the metal ion 10. Most molecular (low molecule) substances may easily form a coordination bond with the first functional group F1 through the metal ion 10. Therefore, even if the target molecule 20 does not form a specific bond with the plasmonic nanostructure 200, SERS-based analysis for the target molecule 20 may be possible. In this regard, according to embodiments of the present invention, the range of substances (molecules) which may be detected/measured by the SERS method may be tremendously expanded.

The first functional group F1, the metal ion 10, and the target molecule 20 having the second functional group F2 may be arranged uniformly or substantially uniformly over the entire surface of the plasmonic nanofilm 100. It may be considered that the first functional group F1, the metal ion 10, and the second functional group F2 are arranged sequentially from the surface side of the plasmonic nanofilm 100. However, the arrangement of the first functional group F1, the metal ion 10, and the target molecule 20 having the second functional group F2 is not limited to that shown in FIG. 1 and may vary in various ways.

The plasmonic nanostructure 200 may be a structure which may induce a surface plasmon effect. The plasmonic nanostructure 200 may be an element for causing (inducing) SERS for the target molecule 20. A SERS effect that a Raman scattering signal is amplified by plasmon may occur between the plasmonic nanostructure 200 and the plasmonic nanofilm 100.

The plasmonic nanostructure 200 may, for example, have a form of a nanoparticle. In this case, the diameter of the nanoparticle may range from several nm to several hundreds of nm. The diameter of the nanoparticle may be about 1 nm or more and less than about 1 μm. As a non-limiting example, the diameter of the nanoparticle may be about 10 nm to about 1000 nm. However, the form of the plasmonic nanostructure 200 is not limited to nanoparticles. For example, the plasmonic nanostructure 200 may have other forms such as a nanowire, a nanotube, etc.

The plasmonic nanostructure 200 may include a metal or be formed of a metal. For example, the plasmonic nanostructure 200 may include at least one of Au, Ag, and Pt. In this case, it may be easy to induce surface plasmons due to the plasmonic nanostructure 200. However, the specific substance of the plasmonic nanostructure 200 is not limited to the above descriptions.

A nanogap may be formed between the plasmonic nanofilm 100 and the plasmonic nanostructure 200, and at least one target molecule 20 may be disposed within the nanogap. For example, the nanogap may be approximately several nm. In the hot-spot area defined by the nanogap, the Raman scattering signal may be amplified and the SERS effect may be induced.

The SERS substrate structure for chemical detection according to an embodiment of the present invention may be said to be a SERS substrate structure using metal-ligand coordination bond. Here, the ligand may be an atom or an atomic group which forms a coordination bond while providing an electron pair to the central metal atom in the complex. The ligand may include the first functional group and/or the second functional group.

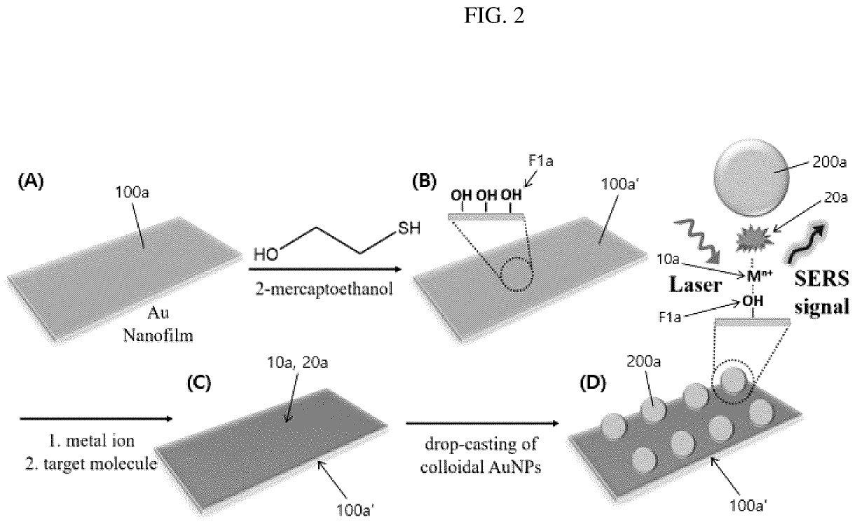

FIG. 2 is a diagram illustrating a manufacturing method of a SERS substrate structure for chemical detection, and a chemical detection method by applying the same (method for detecting a chemical substance by using SERS) according to an embodiment of the present invention.

Referring to FIG. 2, a plasmonic nanofilm 100a′ having a first functional group F1a on a surface may be prepared through steps (A) and (B). This is explained in more detail as follows.

A nanofilm 100a may be prepared in step (A). For example, a flat or substantially flat nanofilm 100a may be formed on a predetermined base substrate through a deposition method using an electron beam. The nanofilm 100a may be called as a plasmonic nanofilm. The nanofilm 100a may contain a metal or be formed of a metal. As a non-limiting example, the nanofilm 100a may be formed to include at least one of Au, Ag, and Pt. As a specific example, the nanofilm 100a may be an Au nanofilm (i.e., AuNF). For example, the nanofilm 100a may have a thickness of about 1 nm or more and less than about 1 μm. The width and length of the nanofilm 100a may be, for example, several millimeters to hundreds of millimeters, but are not limited thereof.

Then, as in step (B), a plasmonic nanofilm 100a′ having the first functional group F1a on the surface may be prepared by introducing the first functional group F1a to the surface of the nanofilm 100a. For example, the first functional group F1a may be introduced to the surface of the nanofilm 100a by treating the surface of the nanofilm 100a with a solution containing a surface modification material. The surface modification material may include 2-mercaptoethanol as a non-limiting example. The nanofilm 100a may be treated by immersing it in a solution containing the surface modification material. The nanofilm 100a may be immersed in a solution containing 2-mercaptoethanol under mild agitation for tens of minutes to several hours (e.g., about 1 hour), and in this process, hydroxyl groups may be activated on the surface of the nanofilm 100a. The plasmonic nanofilm 100a′ having the first functional group F1a may be prepared by washing the surface of the nanofilm 100a treated in this way with an organic solvent (e.g., ethanol). In this case, the first functional group F1a may be a hydroxyl group. The type of the first functional group F1a may change in various ways. For example, the first functional group F1 may include at least one of a hydroxyl group, an amino group, and a carboxyl group.

As a non-limiting example, the thickness of the manufactured plasmonic nanofilm 100a′ may be about 100 nm, and the surface roughness may be about 0.8 nm. Meanwhile, the change in the degree of hydrophilicity of the plasmonic nanofilm 100a′ due to the introduction of the hydroxyl group was confirmed through water contact angle characteristics.

Next, the result as shown in step (C) may be obtained by sequentially performing a step for introducing (attaching) a metal ion 10a onto the surface of the plasmonic nanofilm 100a′, and a step for introducing (attaching) a target molecule 20a having a second functional group on the surface of the plasmonic nanofilm 100a′. Here, the second functional group may form a coordination compound with the first functional group F1a through the metal ion 10a. In other words, the second functional group of the target molecule 20a may form a coordination bond with the first functional group F1a through the metal ion 10a.

The metal ion 10a may include, for example, at least one of Al ion, Ni ion, Cu ion, and Fe ion. The metal ion 10a may be expressed as Mⁿ⁺, where M may be any one of Al, Ni, Cu, and Fe, and n may be 2 to 3. However, the specific type of the metal ion 10 a is not limited to the above and may vary.

The second functional group of the target molecule 20a may include at least one of, for example, a phenol group, a ketone group, a hydroxyl group, an amino group, an azo group, and a carboxyl group. However, the type of the second functional group is not limited to the above description and may vary depending on the case. The second functional group may be a single functional group or a plurality of functional groups.

When the metal ion 10a is an Al ion, in the step for introducing the metal ion 10a, the plasmonic nanofilm 100a′ may be dipped in 1 mM AlK(SO₄)₂ aqueous solution which is a mordant solution for several minutes to several hours (e.g., about 30 minutes), so that a coordination bond between Al³⁺and —OH may be formed on the surface of the plasmonic nanofilm 100a′.

Next, the plasmonic nanofilm 100a′ may be immersed in 100 μM shikonin (i.e., 100 μM shikonin in DIW) in deionized water (DIW) for tens of minutes to several hours (e.g., about 2 hours) under proper heating. As a result of it, the target molecule 20a may be introduced (attached) to the surface of the plasmonic nanofilm 100a′. Here, shikonin may be an example of the target molecule 20a. Furthermore, shikonin may be said to be a dye molecule. Through the above process, the formation of a complex due to coordination between Al³⁺and the functional group (i.e., the second functional group) of the dye molecule may be facilitated and as a result, dyeing of the target molecule 20a may occur on the surface of a plasmonic nanofilm 100a′.

However, the specific method for introducing the above-described metal ion 10a and the target molecule 20a, and the specific substances applied thereof are merely examples and may vary depending on the case.

Next, as shown in step (D), a plasmonic nanostructure 200a inducing SERS may be placed on the surface of the plasmonic nanofilm 100a′ with the metal ion 10a and the target molecule 20a interposed therebetween. One or more plasmonic nanostructures 200a may be placed on the surface of the plasmonic nanofilm 100a′. The plasmonic nanostructure 200a may have a nanoparticle shape, for example. In this case, the diameter of the nanoparticle may range from several nm to several hundreds of nm. The diameter of the nanoparticle may be about 1 nm or more and less than about 1 μm. As a non-limiting example, the diameter of the nanoparticle may be about 10 nm to about 1000 nm. However, the form of the plasmonic nanostructure 200a is not limited to nanoparticles. For example, the plasmonic nanostructure 200a may have other forms such as a nanowire, a nanotube, etc.

The plasmonic nanostructure 200a may include a metal or be formed of a metal. For example, the plasmonic nanostructure 200a may include at least one of Au, Ag, and Pt. In this case, it may be easy to induce surface plasmon due to the plasmonic nanostructure 200a. However, the specific substance of the plasmonic nanostructure 200a is not limited to the above description.

For example, when the plasmonic nanostructure 200a is an Au nanoparticle (i.e., AuNP), the AuNP may be synthesized through a seed-mediated synthesis method based on HAuCl4 reduction, and in this case, a size (diameter) of the AuNP may be approximately 70 nm. Next, the AuNP may be bonded to the plasmonic nanofilm 100a′ through a physical bonding. For example, a nanogap may be formed through a physical bonding of the AuNP and the plasmonic nanofilm 100a′ by using a drop-casting method. As a specific example, a few drops of desalted AuNP dispersion are added dropwise onto the dyed plasmonic nanofilm 100a′ and dried, and as a result of it, a SERS hot-spot may be formed in the interstitial gap between the AuNP and the plasmonic nanofilm 100a′. Here, the plasmonic nanofilm 100a′ may include, for example, Au nanofilm (i.e., AuNF). Therefore, the substrate structure manufactured in the above manner may be referred to as a “dyed AuNP-on-AuNF” substrate structure. However, the synthesis method, introduction method, materials, etc. of the plasmonic nanostructure 200a are not limited to the above description and may vary in various ways.

Next, a step for detecting detect the SERS signal generated between the plasmonic nanofilm 100a′ and the plasmonic nanostructure 200a may be performed. A Raman spectrometer may be used to detect the SERS signal. In other words, the SERS signal generated from the SERS substrate structure may be measured by using Raman spectroscopy.

For example, in an embodiment of the present invention, the SERS spectrum may be a spectrum acquired by using a confocal Raman equipment (LabRAM 300, HORIBA, Japan). In all measurements, the photo-excitation laser wavelength was 660 nm, and a ×100 objective lens (NA=0.90, Olympus, Japan) was used for light collection. For all SERS measurements, the laser power was 10 μW and the acquisition time at each detection point was 10 seconds. The SERS spectrum of Shikonin was measured through SERS mapping with an area of 30×30 μm² and a step size of 1 μm, and the total number of spectra for each mapping was 900. However, the specific methods for detecting SERS signals may change in various ways.

The SERS analysis apparatus according to an embodiment of the present invention may include the SERS substrate structure for chemical detection and a Raman spectrometer for detecting a SERS signal generated from the SERS substrate structure for chemical detection.

According to the embodiments of the present invention described with reference to FIGS. 1 and 2, it is possible to implement a SERS substrate structure for chemical detection which may remarkably expand the range of substances (molecules) that may be detected/measured according to the SERS method. In particular, it is possible to implement a SERS substrate structure that may be used universally for molecular substances which do not form specific bonds with metal nanostructures. In addition, according to embodiments of the present invention, it is possible to implement a SERS substrate structure for chemical detection which are easy to mass-produce and may be easily utilized even by personnel with low technological skills, and a related method. The method for detecting chemical substances by using the SERS substrate structure for chemical detection according to embodiments of the present invention may be usefully applied across a wide range of fields, such as medicine, pharmaceuticals, food, art, etc. The target molecules applied to embodiments of the present invention may include, for example, shikonin, alizarin, 4-mercaptobenzoic acid (4-MBA), etc., but these are merely examples. The types of target molecules may be very diverse depending on the field of application and purpose.

According to one embodiment, the personnel performing the analysis first may measure several molecules using the SERS method using the SERS substrate structure for chemical detection according to an embodiment of the present invention, thereby creating a database or library for several molecules. Then, when measuring an unknown sample by using the SERS substrate structure for chemical detection according to the embodiment, the molecular substances contained in the unknown sample may be confirmed by comparing the measurement data for the unknown sample with the data in the database or library. However, this analysis method is only an example and may vary depending on the case.

In addition, in the embodiment of the present invention, as the metal ion 10a and the target molecule 20a are introduced into the flat plasmonic nanofilm 100a′, and the plasmonic nanostructure 200a is placed thereon, it is not only easy to manufacture the SERS substrate structure, but there is an advantage that the detection of chemical substances (i.e., SERS analysis) using the SERS substrate structure may be easily performed because the SERS substrate structure is easy to handle.

FIG. 3 is a scanning electron microscope (SEM) image showing Au nanoparticles (i.e., AuNPs) which may be applied to a SERS substrate structure for chemical detection according to an embodiment of the present invention.

Referring to FIG. 3, the AuNP may have been synthesized through a seed-mediated synthesis method based on HAuCl₄ reduction. At this time, a size (diameter) of the AuNP may be about 70±4 nm.

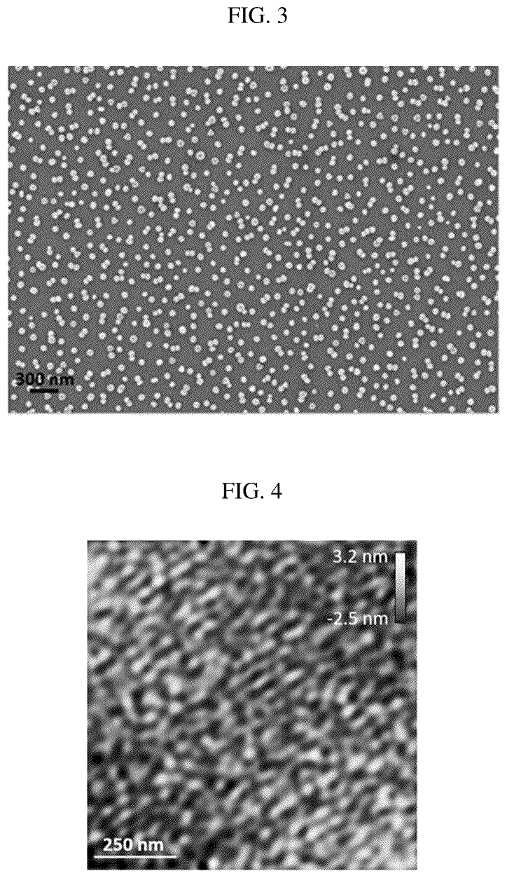

FIG. 4 is an atomic force microscope (AFM) image of the surface of an Au nanofilm (i.e., AuNF) which may be applied to a SERS substrate structure for chemical detection according to an embodiment of the present invention.

Referring to FIG. 4, the AuNF may be formed on a silicon substrate through a deposition method using an electron beam. The surface roughness of the AuNF may be about 0.8 nm.

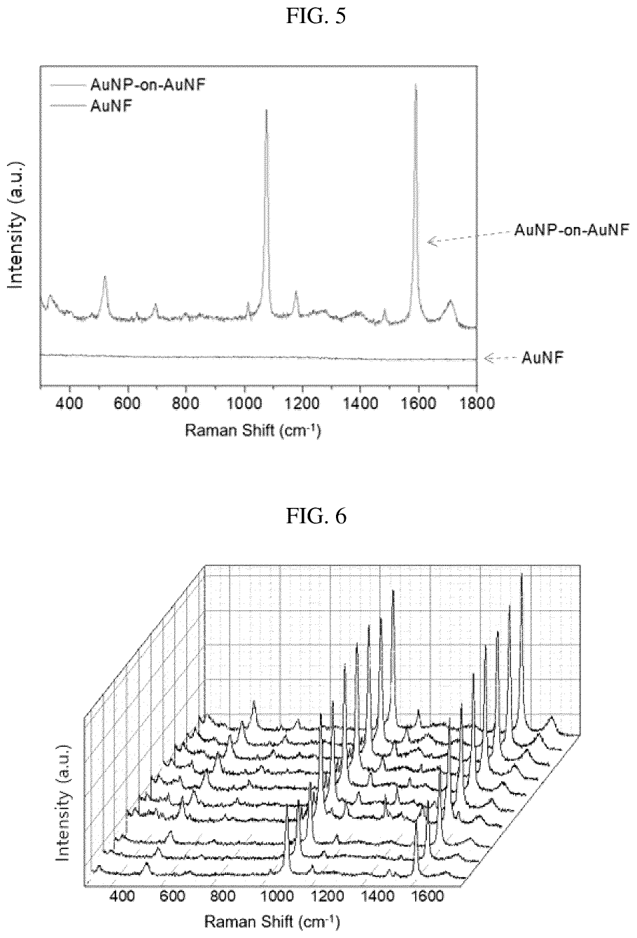

FIG. 5 is a graph illustrating SERS spectrum of 4-mercaptobenzoic acid (4-MBA) for each of a substrate structure (i.e., AuNP-on-AuNF substrate structure) into which AuNPs (plurality of AuNPs) were introduced (attached) on AuNF, and AuNF into which AuNPs were not introduced (attached).

Referring to FIG. 5, it may be seen that a strong SERS signal is detected in the case of the substrate structure (i.e., AuNP-on-AuNF substrate structure) in which AuNPs (plural AuNPs) are introduced (attached) on AuNF. On the other hand, in the case of AuNF without introducing (attaching) AuNPs, no SERS signal was detected. When introducing AuNPs (plural AuNPs) onto AuNF, a SERS hot-spot may be formed due to the AuNPs, and a strong SERS signal may be obtained.

FIG. 6 is a graph showing 4-MBA SERS spectra at different measurement points of a substrate structure (i.e., AuNP-on-AuNF substrate structure) in which AuNPs were introduced (attached) on AuNF. FIG. 6 shows the 4-MBA SERS spectrum obtained at 10 measurement points of the AuNP-on-AuNF substrate structure.

Referring to FIG. 6, it may be seen that the 4-MBA SERS spectra obtained at different measurement points are almost similar or identical. Accordingly, the SERS sensitivity of the AuNP-on-AuNF substrate structure may be uniform or nearly uniform over the entire area of the substrate structure.

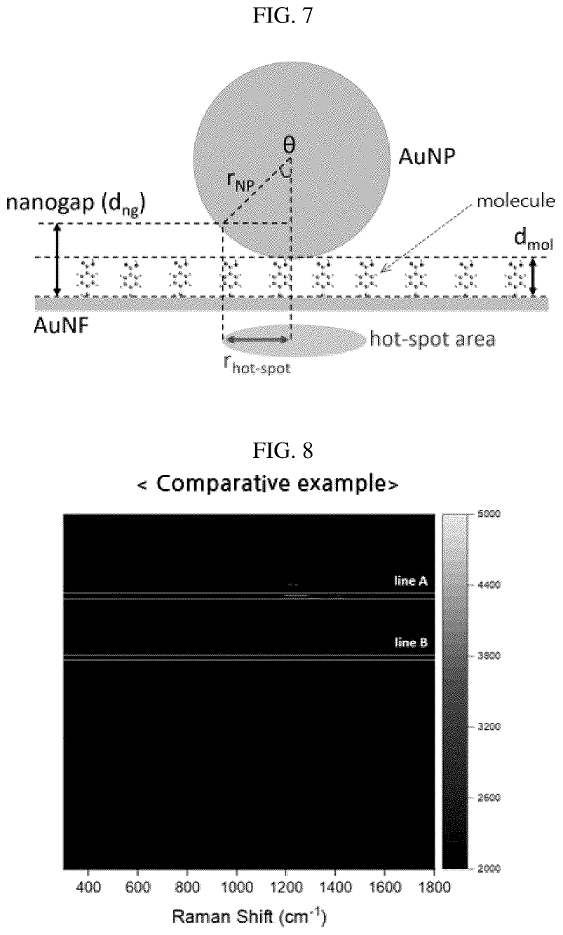

FIG. 7 is a schematic diagram of nanogap setting for calculating SERS enhancement factor (EF) in a nanogap (or a hot-spot) of a substrate structure (i.e., AuNP-on-AuNF substrate structure) in which AuNP is introduced (attached) on AuNF. For convenience, in FIG. 7, the molecules capable of specific binding to AuNP were assumed, and the metal ions were not applied. In FIG. 7, dₘₒₗ means a size (a thickness) of a molecule.

Referring to FIG. 7, when the nanogap is about 5 nm, the central part of the hot-spot area may cover about 3 to 4 molecules. The SERS enhancement index (EF) for 4-MBA in the AuNP-on-AuNF substrate structure was about 4.4×107. Therefore, extremely small amount (nM level) of target substances (target molecules) may be detected. The AuNP-on-AuNF substrate structure (SERS substrate structure) showed very high sensitivity and uniformity of SERS intensity. Therefore, when the molecular substance is well positioned within the nanogap of the AuNP-on-AuNF substrate structure, strong Raman signal enhancement and signal uniformity may be guaranteed.

FIG. 8 is a heatmap graph showing the SERS mapping results for shikonin, the target molecule, when no coordination compound was formed on the AuNP-on-AuNF substrate structure.

Referring to FIG. 8, it may be seen that when a coordination compound mediated by a metal ion is not formed on the AuNP-on-AuNF substrate structure, the SERS signal (spectrum) is not observed in most areas. Merely, a SERS signal due to remaining shikonin may appear in a very small area of the AuNP-on-AuNF substrate structure. For example, in the area corresponding to line A, a SERS signal due to residual shikonin may appear. However, the SERS signal may not appear in the remaining areas except line A (the remaining areas including line B).

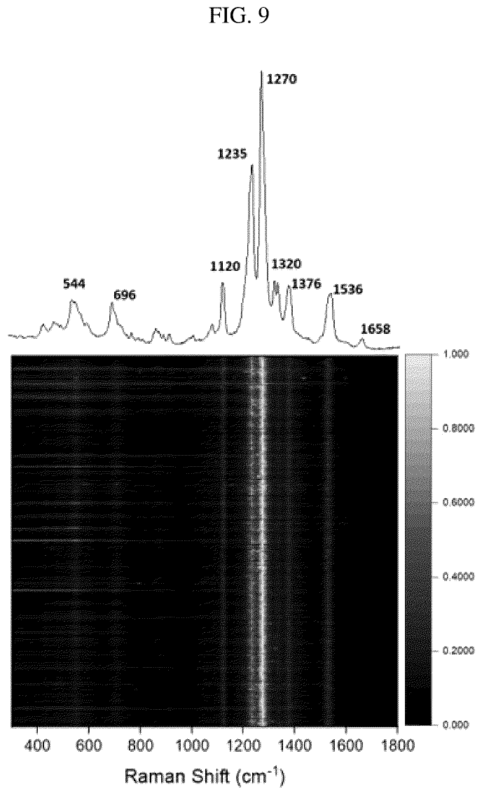

FIG. 9 is a diagram illustrating a heatmap graph (graph illustrated at the lower portion of the drawing) showing the SERS mapping results for shikonin which is a target molecule, and a representative SERS spectrum (spectrum observed at the upper portion of the drawing) when a coordination compound was formed on the AuNP-on-AuNF substrate structure.

Referring to FIG. 9, it is confirmed that when a coordination compound is formed using a metal ion (e.g., Al ion) on the AuNP-on-AuNF substrate structure, the SERS spectrum of shikonin is observed over the entire area of the AuNP-on-AuNF substrate structure. The SERS spectrum appeared generally uniform across the entire area of the AuNP-on-AuNF substrate structure.

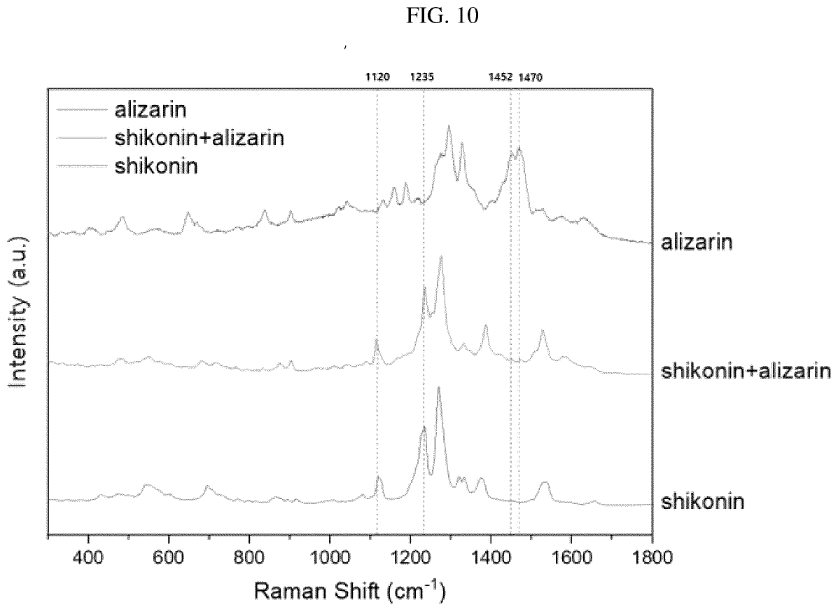

FIG. 10 is a graph showing the results of SERS analysis of various molecular substances obtained by using an AuNP-on-AuNF substrate structure to which a coordination compound prepared according to an embodiment of the present invention is applied. FIG. 10 includes data for the case using shikonin as a target molecule, the case using alizarin as a target molecule, and the case (shikonin+alizarin) using a 1:1 mixture of shikonin and alizarin as a target molecule.

Referring to FIG. 10, when a mixture of shikonin and alizarin was used as a target molecule (shikonin+alizarin), the shikonin characteristic SERS band (1120, 1235 cm⁻¹) and the alizarin characteristic SERS band (1452, 1470 cm⁻¹) were all observed in the SERS spectrum. Therefore, it may be confirmed that simultaneous multiple analysis of multiple target molecules is possible by using the AuNP-on-AuNF substrate structure to which the coordination compound prepared according to the example is applied.

According to the embodiments of the present invention described above, it is possible to implement a SERS substrate structure for chemical detection which may remarkably expand the range of substances (molecules) which may be detected/measured by the SERS method. In particular, it is possible to implement a SERS substrate structure which may be used universally for molecular substances which do not form specific bonds with metal nanostructures. In addition, according to embodiments of the present invention, it is possible to implement a SERS substrate structure for chemical detection which may be easy to be mass-produced and may be easily utilized even by personnel with low technological skills, and a related method thereof. The method for detecting chemical substances using the SERS substrate structure for chemical detection according to embodiments of the present invention may be usefully applied across a wide range of fields, such as medicine, pharmaceuticals, food, art, etc.

In this specification, the preferred embodiments of the present invention have been disclosed, and although specific terms have been used, they are only used in a general sense to easily explain the technological content of the present invention and to help understanding the present invention, and they are not used to limit the scope of the present invention. It is obvious to those having ordinary skill in the related art to which the present invention belong that other modifications based on the technological idea of the present invention may be implemented in addition to the embodiments disclosed herein. It will be understood to those having ordinary skill in the related art that in connection with SERS substrate structures for chemical detection, manufacturing methods thereof, and chemical detection methods using SERS according to the embodiments described with reference to FIGS. 1 to 7, 9, and 10, various substitutions, changes, and modifications may be made without departing from the technological spirit of the present invention. Therefore, the scope of the invention should not be determined by the described embodiments, but should be determined by the technological concepts described in the claims.

### INDUSTRIAL APPLICARILITY

The embodiments of the present invention may be applied to the structures for detecting substances, their manufacturing and use. The embodiments of the present invention may be applied to a substrate structure for detecting chemical substances, a manufacturing method thereof, and a method for detecting chemical substances.

1. A SERS substrate structure for chemical detection comprising:
a plasmonic nanofilm having a first functional group on a surface;
a metal ion disposed on the surface of the plasmonic nanofilm;
a target molecule disposed on the surface of the plasmonic nanofilm and having a second functional group; and
a plasmonic nanostructure which is disposed on the surface of the plasmonic nanofilm with the metal ion and the target molecule interposed therebetween to cause surface-enhanced Raman scattering (SERS),
wherein the first functional group and the second functional group form a coordination compound through the metal ion.

2. The SERS substrate structure for chemical detection of claim 1, wherein the plasmonic nanofilm includes a metal.

3. The SERS substrate structure for chemical detection of claim 2, wherein the plasmonic nanofilm includes at least one of Au, Ag, and Pt.

4. The SERS substrate structure for chemical detection of claim 1, wherein the first functional group includes at least one of a hydroxyl group, an amino group, and a carboxyl group.

5. The SERS substrate structure for chemical detection of claim 1, wherein the metal ion includes at least one of Al ion, Ni ion, Cu ion, and Fe ion.

6. The SERS substrate structure for chemical detection of claim 1, wherein the second functional group includes at least one of a phenol group, a ketone group, a hydroxyl group, an amino group, an azo group, and a carboxyl group.

7. The SERS substrate structure for chemical detection of claim 1, wherein the plasmonic nanostructure has a form of a nanoparticle.

8. The SERS substrate structure for chemical detection of claim 1, wherein the plasmonic nanostructure includes a metal.

9. The SERS substrate structure for chemical detection of claim 8, wherein the plasmonic nanostructure includes at least one of Au, Ag, and Pt.

10. A chemical detection method using SERS comprising:
preparing a plasmonic nanofilm having a first functional group on a surface;
introducing a metal ion onto the surface of the plasmonic nanofilm;
introducing a target molecule having a second functional group on the surface of the plasmonic nanofilm to induce the first functional group and the second functional group to form a coordination compound through the metal ion;
disposing a plasmonic nanostructure which causes surface-enhanced Raman scattering (SERS) on the surface of the plasmonic nanofilm with the metal ion and the target molecule interposed therebetween; and
detecting a SERS signal generated between the plasmonic nanofilm and the plasmonic nanostructure.

11. The chemical detection method using SERS of claim 10, wherein the preparing the plasmonic nanofilm having the first functional group includes:
preparing a nanofilm; and
introducing the first functional group to a surface of the nanofilm by treating the surface of the nanofilm with a solution containing a surface modification material.

12. The chemical detection method using SERS of claim 11, wherein the surface modification material includes 2-mercaptoethanol.

13. The chemical detection method using SERS of claim 10, wherein the plasmonic nanofilm includes a metal.

14. The chemical detection method using SERS of claim 13, wherein the plasmonic nanofilm includes at least one of Au, Ag, and Pt.

15. The chemical detection method using SERS of claim 10, wherein the first functional group includes at least one of a hydroxyl group, an amino group, and a carboxyl group.

16. The chemical detection method using SERS of claim 10, wherein the metal ion includes at least one of Al ion, Ni ion, Cu ion, and Fe ion.

17. The chemical detection method using SERS of claim 10, wherein the second functional group includes at least one of a phenol group, a ketone group, a hydroxyl group, an amino group, an azo group, and a carboxyl group.

18. The chemical detection method using SERS of claim 10, wherein the plasmonic nanostructure has a form of a nanoparticle.

19. The chemical detection method using SERS of claim 10, wherein the plasmonic nanostructure includes a metal.

20. The chemical detection method using SERS of claim 19, wherein the plasmonic nanostructure includes at least one of Au, Ag, and Pt.
